(19) United States
(12) Patent Application Publication
(10) Pub. No.: US 2014/0028297 A1
(43) Pub. Date: Jan. 30, 2014

(54) ENCODER ELEMENT AND METHOD FOR PRODUCTION THEREOF

(71) Applicant: Robert Bosch GmbH, Stuttgart (DE)

(72) Inventors: Martin Maier, Moeglingen (DE); Helmut Schneider, Aichtal (DE); Nikolaus Hautmann, Ditzingen (DE); Dietmar Uhlenbrock, Stuttgart (DE); Ralf Diekmann, Schwieberdingen (DE)

(21) Appl. No.: 13/940,760

(22) Filed: Jul. 12, 2013

(30) Foreign Application Priority Data
Jul. 27, 2012 (DE) 10 2012 213 245.7

(51) Int. Cl. B05D 5/00; G01B 7/30

(52) U.S. Cl. CPC B05D 5/00; G01B 7/30
USPC 324/207.25; 427/598; 264/400

(57) ABSTRACT

A method for producing an encoder element having a base body and a magnetic plastics element includes providing the base body and mixing a plastics base material with a magnetic or magnetizable filler to form an injection-molding material. The method also includes spraying the injection-molding material onto the base body so that a material-bonding, direct connection is produced between the base body and the sprayed-on plastics element. The method also includes magnetizing the sprayed-on plastics element.

This application claims priority under 35 U.S.C. §119 to patent application no. DE 10 2012 213 245.7, filed on Jul. 27, 2012 in Germany, the disclosure of which is incorporated herein by reference in its entirety.

### BACKGROUND

The present disclosure relates to a method for producing an encoder element and to such an encoder element with magnetic properties.

Magnetic encoder wheels are used for example in the area of the automotive industry very often in conjunction with ABS systems, on camshafts, on crankshafts and steering devices. To produce such encoder wheels, a rubber material mixed with magnetic filling material is usually vulcanized onto a metal wheel. Encoder wheels of this type have proven to be successful, particularly in the area of automotive engineering, where there are great alternating stresses as a result of changing temperatures and, for example, in winter contact with salt-containing water and the like is possible. Disadvantages of the vulcanized-on rubber magnetic element is, however, that it causes relatively high costs and furthermore, as a result of the vulcanizing process, can only be applied with a certain minimum thickness. Furthermore, DE 102005022451 A1 discloses an encoder wheel in which an adhesive layer of an acrylic adhesive is provided between a supporting component and an encoder element. However, this known method is likewise very costly and must be performed with extremely high manufacturing accuracy, which in practice leads to high reject rates in production. It would consequently be desirable to have a method for producing an encoder element that can be performed at lowest possible cost and can meet the expected requirements, in particular in applications in automotive engineering.

### SUMMARY

The method according to the disclosure for producing an encoder element with the features described below has in comparison the advantage that the method can be carried out very quickly and at low cost. Furthermore, a connection between a base body and a magnetic plastics element that is absolutely seal-tight is thereby obtained. There is consequently no risk of water or other liquids being able to get into the region between the base body and the plastics element. Furthermore, according to the disclosure it is possible to dispense with the use of vulcanized or unvulcanized rubber or the like. After the step of applying the plastics element to the base body, no further subsequent working is necessary, and the method according to the disclosure makes simple and technically reliable automation possible, along with extremely high precision of the component produced. This is achieved according to the disclosure by a base body and a injection-molding material that can be sprayed on being provided in the method according to the disclosure, the injection-molding material being a mixture of a plastics material, in particular granules of plastic, with a magnetic and/or magnetizable filler. The injection-molding material prepared in this way is sprayed onto the base body in a subsequent injection-molding step. This creates a seal-tight, material-bonded direct connection between the base body and the magnetic plastics element. In a final step, the sprayed-on plastics element is subsequently magnetized, in order to provide a customary multipole arrangement of the encoder element.

The description below shows preferred developments of the disclosure.

In order to improve adhesion of the sprayed-on injection-molding granules, before the spraying-on step nanostructures are produced on the surface in regions of the base body at which the plastics element is to be sprayed on. The nanostructures are preferably irregular structures, in particular cauliflower-like structures. Alternatively, the nanostructures are regular structures, in particular lines.

It is particularly preferred for the nanostructures to be produced by means of an ultrashort pulsed laser. Alternatively, the nanostructures are produced by means of an etching process.

It is further preferred for the plastics element to have a thickness of less than 1 mm, and in particular a thickness of less than 0.8 mm This allows the encoder element according to the disclosure also to be used in confined installation spaces.

It is particularly preferred for the base body to be a metal, and in particular a sheet metal. It is further preferred for the base body to be substantially circular. It is preferred for the plastics element to comprise a thermoplastic material.

It is further preferred for the plastics element to be arranged on a circumferential region of the circular base body. It is particularly preferred for the plastics element thereby to cover the circumferential region of the circular base body completely. Since the plastics element can be sprayed onto the circumferential region of the base body in one step by means of injection molding, no subsequent working, such as for example removal of edges or the like, is necessary here.

Furthermore, the present disclosure relates to an encoder element, in particular an encoder wheel, which comprises a base body, in particular a circular metal body, and a magnetic plastics element. In this case, a direct, material-bonding connection is formed between the base body and the plastics element.

It is preferred for the encoder element according to the disclosure to have nanostructures on the base body in a region in which the plastics element is sprayed on. The nanostructures may have regular or irregular forms.

The encoder elements according to the disclosure may be used in particular in automotive engineering, for example on shafts or bearings, in connection with rotary and position sensors, etc. An application in the case of machines and tools, in particular electrical hand-held tools, is likewise conceivable.

### BRIEF DESCRIPTION OF THE DRAWINGS

A preferred exemplary embodiment of the disclosure is described below in detail with reference to the accompanying drawing, in which:

FIGS. 1 to 4 show schematic views that illustrate the steps for producing an encoder element.

### DETAILED DESCRIPTION

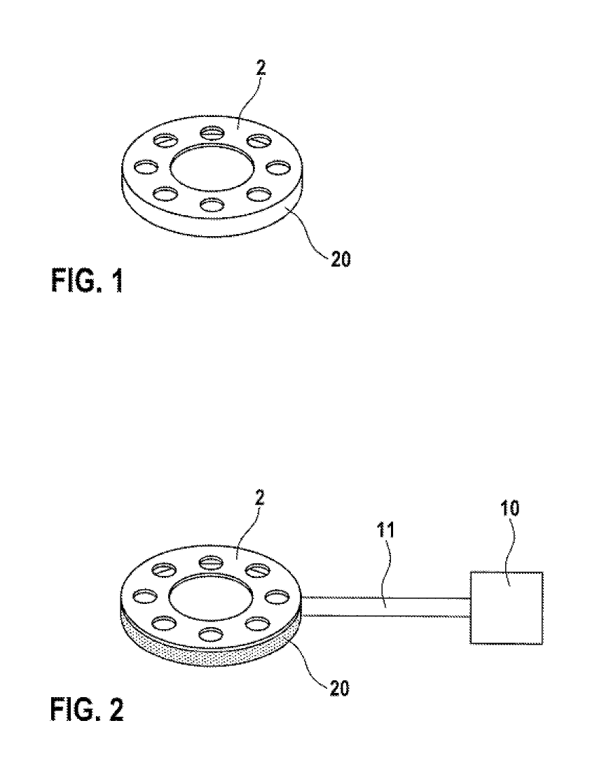

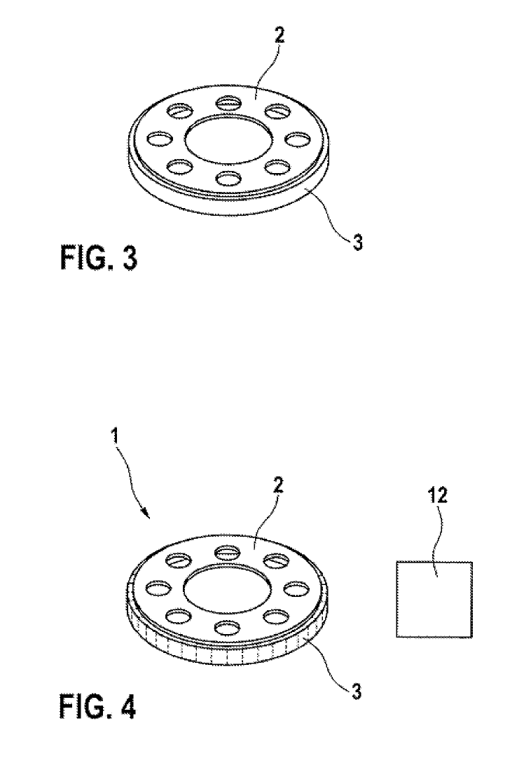

A method according to the disclosure for producing an encoder element and an encoder element 1 according to the disclosure are described in detail below with reference to FIGS. 1 to 4.

In this exemplary embodiment, the encoder element 1 according to the disclosure is an encoder wheel, which comprises a circular base body 2 and a plastics element 3. The plastics element 3 is in this case arranged on an outer circumferential surface 20 of the base body 2 by means of a direct, material-bonding connection. The plastics elements 3 is sprayed onto the outer circumferential surface 20 of the base body 2 by means of an injection-molding operation. The plastics element 3 comprises a thermoplastic material and also a magnetic or magnetizable filler. Along the circumference, the plastics element has alternately provided polarizations, in order to provide a multipole encoder wheel.

The method according to the disclosure is clear from FIGS. 1 to 4. In a first step, in FIG. 1, a circular base body 2 of a metallic sheet material is provided. The base body 2 has an outer circumferential surface 20 with a predetermined width. In a next step, shown in FIG. 2, the outer circumferential surface 20 of the base body 2 is worked by means of an ultrashort pulsed laser 10 in such a way that nanostructures are produced on the outer circumferential surface 20. In this case, a laser beam 11 of the ultrashort pulsed laser 10 is directed exclusively onto the outer circumferential surface 20, the nanostructures being provided along the entire circumference of the outer circumferential surface 20. For this purpose, the base body 20 is preferably rotated correspondingly. In a next step, injection-molding granules comprising granules of plastic with which a magnetic or magnetizable filler is admixed are provided. These injection-molding granules are then sprayed onto the entire outer circumferential surface 20 of the base body 2, so that a magnetic plastics element 3 is provided on the outer circumferential surface 20. A direct, material-bonding connection, which in particular is liquid-tight, is formed here between the plastics element 3 and the base body 2. Consequently, no liquid can get into a region between the base body 2 and the plastics element 3. Subsequently, in a final step, as indicated in FIG. 4, a multiplicity of magnetic poles are produced on the plastics element 3 by means of a magnetizing device 12. In this way, the encoder element 1 is provided with a multiplicity of alternating, magnetic north and south poles.

Consequently, the concept according to the disclosure allows a thermoplastic base material with a magnetic or magnetizable filler to be used instead of rubber as the base material for the multipole encoder element, which is considerably less costly than rubber. Likewise, in terms of the technical process, it is less costly for the magnetic or magnetizable filler to be mixed with a plastics base material. A more homogeneous distribution of the magnetic or magnetizable fillers in the plastics base material can also be realized more easily than in a rubber material.

Furthermore, the operation of peripherally spray-coating with the injection-molding material is technically reliable and of low cost, and can be automated very easily. In particular, there is also no need here for any subsequent work, and the plastics element can be applied to the base body 2 with extremely high precision. In comparison with the previous methods of production, it is consequently possible according to the disclosure to dispense with a number of manufacturing steps, so that the method according to the disclosure can be realized at very low cost.

Since the plastics element adheres directly to the base body, thinner layer thicknesses of the plastics element than in comparison with the prior art are possible. Furthermore, the use of the plastics base material makes it possible to have a great selection of base materials (thermoplastics), for example polymeric base materials, which can be selected appropriately for the respective intended use. A further advantage of sprayed application of the plastics element onto the base body is that of improved concentricity properties and reduced imbalances. Furthermore, the material for the base body can also be selected according to the intended use, for example VA steel, aluminum, cold strip or sheet metal.

What is claimed is:

1. A method for producing an encoder element having a base body and a magnetic plastics element, the method comprising:
mixing a plastics base material with a magnetic or magnetizable filler to form an injection-molding material;
spraying the injection-molding material onto the base body to produce a material-bonding, direct connection between the base body and the sprayed-on plastics element; and
magnetizing the sprayed-on plastics element.

2. The method according to claim 1, further comprising:
before spraying on the injection-molding material, providing a nanostructure to regions of the base body onto which the injection-molding material is to be sprayed.

3. The method according to claim 2, wherein providing the nanostructure includes producing the nanostructure with an ultrashort pulsed laser.

4. The method according to claim 2, wherein providing the nanostructures includes producing the nanostructure with an etching process.

5. The method according to claim 1, wherein the plastics element has a thickness of less than 1 mm.

6. The method according to claim 1, wherein the base body is a substantially circular base body, and spraying the injection-molding material onto the base body includes spraying the injection-molding material onto an outer circumferential surface of the base body.

7. An encoder element, comprising:
a base body; and
a magnetic plastics element,
wherein a direct material-bonding connection is formed between the base body and the magnetic plastics element.

8. The encoder element according to claim 7, wherein the base body has nanostructures in a region of the direct material-bonding connection to the magnetic plastics element.

9. The encoder element according to claim 8, wherein the nanostructures are provided on an entire surface area on which there is the direct material-bonding connection to the magnetic plastics element.

10. The encoder element according to claim 7, wherein the magnetic plastics element has a thickness of less than 1 mm.
